(19) United States
(12) Patent Application Publication
(10) Pub. No.: US 2026/0015022 A1
(43) Pub. Date: Jan. 15, 2026

(54) PORTABLE FOLDING PULLING CART

(71) Applicant: Xiamen Roadzup Outdoor Products Co., Ltd., Xiamen City (CN)

(72) Inventor: Changjiu Huang, Xiamen City (CN)

(21) Appl. No.: 19/243,240

(22) Filed: Jun. 19, 2025

(30) Foreign Application Priority Data
Jul. 15, 2024 (CN) 202421670460.0

(51) Int. Cl. B62B 3/02

(52) U.S. Cl. CPC B62B 3/02; B62B 2205/06; B62B 2301/04

(57) ABSTRACT

A portable folding pulling cart includes a pulling cart frame. The pulling cart frame includes a folding frame and a wheel mechanism configured to be mounted on the folding frame. The folding frame includes two first scissor mechanisms arranged at intervals in a left-and-right direction and two second scissor mechanisms arranged at intervals in a front-and-rear direction. Each of the two first scissor mechanisms includes at least two first scissor units, and each of the two second scissor mechanisms includes at least one second scissor unit. An upper part of one of connecting rods of adjacent two first scissor units is bent. The upper ends of the adjacent two first scissor units are respectively pivotally connected to two upper pivoting points, and the lower ends of the adjacent two first scissor units of the at least two first scissor units are respectively pivotally connected to two lower pivoting points.

### RELATED APPLICATIONS

This application claims priority to Chinese patent application number 202421670460.0, filed on Jul. 15, 2024. Chinese patent application number 202421670460.0 is incorporated herein by reference.

### FIELD OF THE DISCLOSURE

The present disclosure relates to a portable pulling cart, and in particular to a portable folding pulling cart.

### BACKGROUND OF THE DISCLOSURE

The existing portable foldable pulling carts, such as CN108725533A, comprise a pulling cart frame that comprises a foldable frame and a wheel assembly attachable to the foldable frame. The foldable frame comprises two first scissor mechanisms arranged at left-right intervals and two second scissor mechanisms arranged at front-rear intervals. Each of the two first scissor mechanisms comprises two first scissor units, while each of the two second scissor mechanisms has a single one second scissor unit. The two first scissor mechanisms and the two second scissor mechanisms are connected to form a rectangular structure, with adjacent first and second scissor units rotatably connected at upper ends of the adjacent first and second scissor units via first upper seats and at lower ends of the adjacent first and second scissor units through first lower seats. In the two first scissor mechanisms, the adjacent connecting rods of the two first scissor units are horizontally arranged and pivotally connected at upper ends of the adjacent connecting rods, with pivot axes of the adjacent connecting rods aligned coaxially. This configuration necessitates that a width of the upper seat must exceed a sum of outer diameters of the two connecting rods, resulting in reduced interior width within the pulling cart. Consequently, there exists a need for further improvement. Similarly, other patents like CN103587562B, CN103895672B, and U.S. Pat. No. 9,073,564B2 also connect adjacent connecting rods of the two first scissor units through a single shaft, thereby suffering from the aforementioned shortcomings.

### BRIEF SUMMARY OF THE DISCLOSURE

The technical problem to be solved by the present disclosure is to provide a portable folding pulling cart.

The technical solution adopted by the present disclosure to solve the technical problem is to provide a portable folding pulling cart, and the portable folding pulling cart comprises a pulling cart frame. The pulling cart frame comprises a folding frame and a wheel mechanism configured to be mounted on the folding frame. The folding frame comprises two first scissor mechanisms arranged at intervals in a left-and-right direction and two second scissor mechanisms arranged at intervals in a front-and-rear direction. Each of the two first scissor mechanisms comprises at least two first scissor units, and each of the two second scissor mechanisms comprises at least one second scissor unit. The two first scissor mechanisms and the two second scissor mechanisms are connected to form a rectangular structure, and an upper end of each of the at least two first scissor units and an upper end of the at least one second scissor unit adjacent to a corresponding one of the at least two first scissor units are rotatably connected together through a first upper seat. A lower end of each of the at least two first scissor units and a lower end of the at least one second scissor unit adjacent to the corresponding one of the at least two first scissor units are rotatably connected together through a first lower seat. A middle part of each of the two first scissor mechanisms further comprises a second upper seat and a second lower seat, and the second upper seat comprises two upper pivoting points. The two upper pivoting points are spaced apart from each other in the front-and-rear direction and aligned with each other in the left-and-right direction, and the second lower seat comprises two lower pivoting points. Each of the at least two first scissor units comprises connecting rods, and an upper part of one of the connecting rods of adjacent two first scissor units of the at least two first scissor units is bent. The upper ends of the adjacent two first scissor units are respectively pivotally connected to the two upper pivoting points of the second upper seat, and the lower ends of the adjacent two first scissor units are respectively pivotally connected to the two lower pivoting points of the second lower seat.

In an embodiment, the first upper seat and the first lower seat corresponding to the first upper seat are connected together through a first telescopic rod assembly, and the second upper seat and the second lower seat corresponding to the second upper seat are connected together through a second telescopic rod assembly.

In an embodiment, the two lower pivoting points on the second lower seat are spaced apart from each other in the front-and-rear direction and misaligned with each other in the left-and-right direction.

In an embodiment, each of the at least two first scissor units and the at least one second scissor unit comprises two connecting rods of the connecting rods rotatably connected together at a middle position of the two connecting rods, and the two connecting rods of each of the at least two first scissor units intersect and are respectively arranged inside and outside the folding frame. In the adjacent two first scissor units: the upper part of one of the two connecting rods located inside the folding frame of a first one of the adjacent two first scissor units is bent outwardly and rotatably connected to a first one of the two upper pivoting points of the second upper seat, and the upper part of one of the two connecting rods located outside the folding frame of a second one of the adjacent two first scissor units is rotatably connected to a second one of the two upper pivoting points of the second upper seat.

In an embodiment, the folding frame further comprises a base frame, and the base frame comprises a plurality of radiating mechanisms in a one-to-one correspondence with the at least two first scissor units of each of the two first scissor mechanisms and arranged at intervals in the front-and-rear direction. Each of the plurality of radiating mechanisms comprises a middle seat and four bottom rods that are configured to be rotatably connected to the middle seat. Distal ends of two of the four bottom rods are respectively rotatably connected to two first lower seats of the first lower seats, and distal ends of another two of the four bottom rods are respectively rotatably connected to two second lower seats of the second lower seats.

In an embodiment, the wheel mechanism is located below the first lower seat and is configured to be detachably connected to the folding frame.

In an embodiment, the wheel mechanism comprises a U-shaped wheel frame, a wheel, and a first connecting shaft. The U-shaped wheel frame has a common plate and two split plates respectively fixedly connected to two sides of the common plate, and the wheel is configured to be rotatably connected between the two split plates. The first connecting shaft is connected to the common plate, and the first connecting shaft is configured to be assembled and disassembled on the folding frame. A first annular groove is recessed on an upper part of the first connecting shaft, and the first telescopic rod assembly comprises an outer tube and an inner tube slidably arranged in the outer tube. The first lower seat is fixedly connected to a bottom of the outer tube, and a top of the inner tube and the first upper seat are fixedly connected together. The bottom of the outer tube is fixedly disposed with a mounting member, and the mounting member comprises a sliding groove horizontally arranged. An area of the outer tube corresponding to the sliding groove comprises an outer through hole that penetrates through the outer tube in an inside-and-outside direction, and a fixed sleeve is fixedly disposed in the bottom of the outer tube. The fixed sleeve comprises an inner through hole corresponding to the outer through hole, and the first connecting shaft is adapted to be disposed in the fixed sleeve. The sliding groove of the mounting member is slidably disposed with a sliding seat that is configured to slide horizontally, and the sliding seat comprises a first insertion portion. The first insertion portion is configured to extend into the outer through hole and the inner through hole and be disposed in the first annular groove.

In an embodiment, the sliding seat comprises a first side plate and a second side plate that are relatively fixed and horizontally spaced apart, and the first side plate is located outside a first side of the outer tube where the outer through hole is provided. The first side plate is fixedly disposed with the first insertion portion, and the second side plate is located outside a second side of the outer tube that faces away from the first side. A first elastic body is disposed between the second side plate and the outer tube.

In an embodiment, the sliding seat comprises a rectangular frame, and two side plates of the rectangular frame facing each other define the first side plate and the second side plate. The outer tube is located inside the rectangular frame, and the mounting member comprises a lower mounting portion and an upper mounting portion. The sliding groove is formed between the upper mounting portion and the lower mounting portion.

In an embodiment, the wheel mechanism comprises a supporting frame and two wheels configured to be rotatably connected to two sides of the supporting frame. The first telescopic rod assembly comprises an outer tube and an inner tube slidably arranged in the outer tube, and the first lower seat is fixedly connected to a bottom of the outer tube. A top of the inner tube and the first upper seat are fixedly connected together, and a second connecting shaft is fixedly provided at the bottom of the outer tube. The supporting frame and the second connecting shaft are configured to be assembled together and detached from each other, and a lower part of the second connecting shaft is recessed with a second annular groove. The supporting frame is recessed with an insertion hole, and the supporting frame comprises a first through hole that penetrates through an inside and an outside of the insertion hole, the second connecting shaft is adapted to be disposed in the insertion hole. The wheel mechanism further comprises an L-shaped frame, and a middle part of L-shaped frame is rotatably connected to a bottom of the supporting frame. A second elastic body is disposed between a first end of the L-shaped frame and the bottom of the supporting frame, and a second insertion portion is fixedly disposed at a second end of the L-shaped frame. The second insertion portion is configured to extend into the first through hole and be disposed in the second annular groove.

Compared with the existing techniques, the technical solution has the following advantages.

The second upper seat comprises the two upper pivoting points, and the two upper pivoting points are spaced apart from each other in the front-and-rear direction and aligned with each other in the left-and-right direction. The second lower seat comprises the two lower pivoting points, and the upper part of the one of connecting rods of the adjacent two first scissor units is bent. The upper ends of the adjacent two first scissor units are respectively pivotally connected to the two upper pivoting points of the second upper seat, and the lower ends of the adjacent two first scissor units are respectively pivotally connected to the two lower pivoting points of the second lower seat. As a result: 1) the width of the second upper seat is reduced to increase a width of an internal space of the pulling cart frame; and 2) each of the connecting rods is connected to different pivot positions of the second upper seat and the lower seat, and a rotation axis between each of the connecting rods and the second upper seat of the adjacent two first scissor units is independent, so connection strength is better.

### BRIEF DESCRIPTION OF THE DRAWINGS

The present disclosure is further described below in conjunction with the accompanying drawings and specific implementation methods.

FIG. 1 is a perspective view of a pulling cart according to Embodiment 1.

FIG. 2 is a perspective view of the pulling cart frame of Embodiment 1 in an unfolded state.

FIG. 3 is a perspective view of the pulling cart frame of Embodiment 1 in a half-folded state.

FIG. 4 is a perspective view of the pulling cart frame in a folded state and a pulling rod mechanism in a splayed state according to Embodiment 1.

FIG. 5 is a perspective view of the pulling cart frame in the folded state and the pulling rod mechanism in a half-folded state according to Embodiment 1.

FIG. 6 is a perspective view of the pulling cart frame in the folded state and the pulling rod mechanism in a folded state in Embodiment 1.

FIG. 7 is a perspective view of the pulling cart frame in the folded state with a wheel mechanism disassembled according to Embodiment 1.

FIG. 8 is an exploded view of the wheel mechanism of the pulling cart frame in Embodiment 1.

FIG. 9 is a front view of the wheel mechanism of the pulling cart frame according to Embodiment 1.

FIG. 10 is a partial view of the A-A section in FIG. 9.

FIG. 11 is a partially enlarged view of FIG. 8.

FIG. 12 is an enlarged view of an encircled portion B in FIG. 10.

FIG. 13 is a partial view of the C-C section in FIG. 9.

FIG. 14 is a perspective view of a pulling cart frame of Embodiment 2 in an unfolded state.

FIG. 15 is a perspective view of a pulling cart frame of Embodiment 3 in an unfolded state.

FIG. 16 is a perspective view of the pulling cart frame of Embodiment 3 in a folded state.

FIG. 17 is a perspective view of the pulling cart frame of Embodiment 3 in the folded state with a wheel mechanism disassembled.

FIG. 18 is an exploded view of the wheel mechanism of the pulling cart frame of Embodiment 3.

FIG. 19 is a partially enlarged view of FIG. 18.

FIG. 20 is a first partially enlarged cross-sectional view of the wheel mechanism of the pulling cart frame of Embodiment 3.

FIG. 21 is a second partially enlarged cross-sectional view of the wheel mechanism of the pulling cart frame of Embodiment 3.

FIG. 22 is a perspective view of a pulling cart frame of Embodiment 4 in an unfolded state.

### DESCRIPTION OF LABELS

Pulling cart frame 100, pulling cart cloth 200, folding frame 10; first scissor mechanism 11, first scissor unit 111, connecting rod 112; second scissor mechanism 12, second scissor unit 121; first upper seat 131, first lower seat 132, first telescopic rod assembly 133, outer tube 1331, inner tube 1332, second upper seat 141, second lower seat 142, second telescopic rod assembly 143, upper pivoting point 1411, lower pivoting point 1421; radiating mechanism 15, middle seat 151, bottom rod 152; wheel mechanism 20, U-shaped wheel frame 21, wheel 22, first connecting shaft 23, first annular groove 231, sliding groove 24, outer through hole 25, fixed sleeve 26, inner through hole 27, sliding seat 28, first insertion portion 281, first side plate 282, second side plate 283, first elastic body 284, lower mounting portion 291, upper mounting portion 292; first pulling rod mechanism 30, first assembly seat 31, first pulling rod 32, first gripping rod 33, middle portion seat 122, supporting frame 201, second connecting shaft 202, insertion hole 203, first through hole 204, second annular groove 205, L-shaped frame 206, second elastic body 207, and second insertion portion 208.

### DETAILED DESCRIPTION OF THE EMBODIMENTS

### Embodiment 1

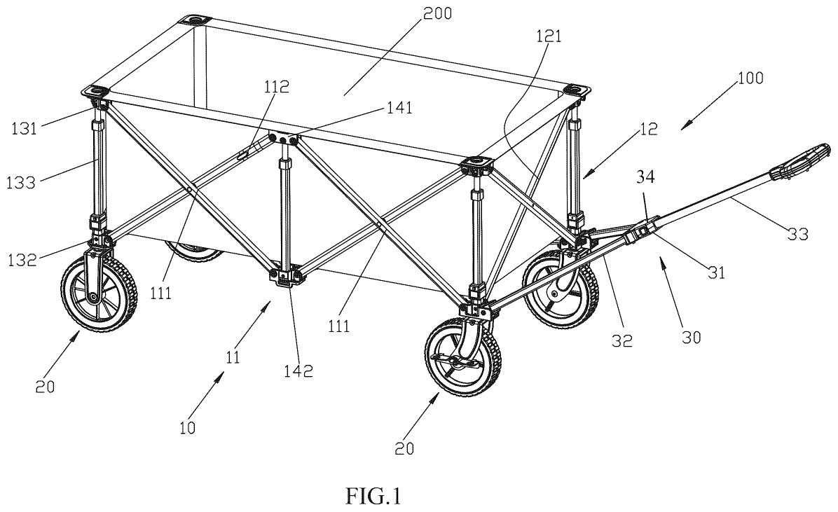

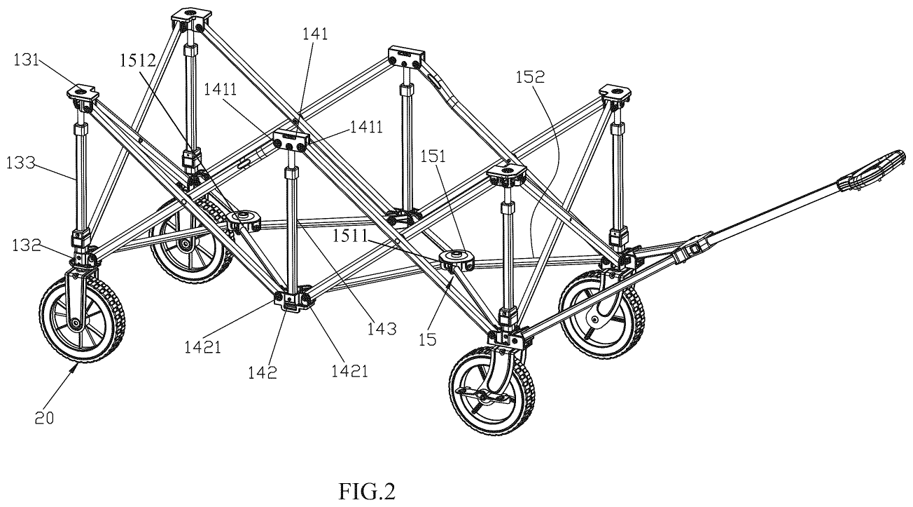

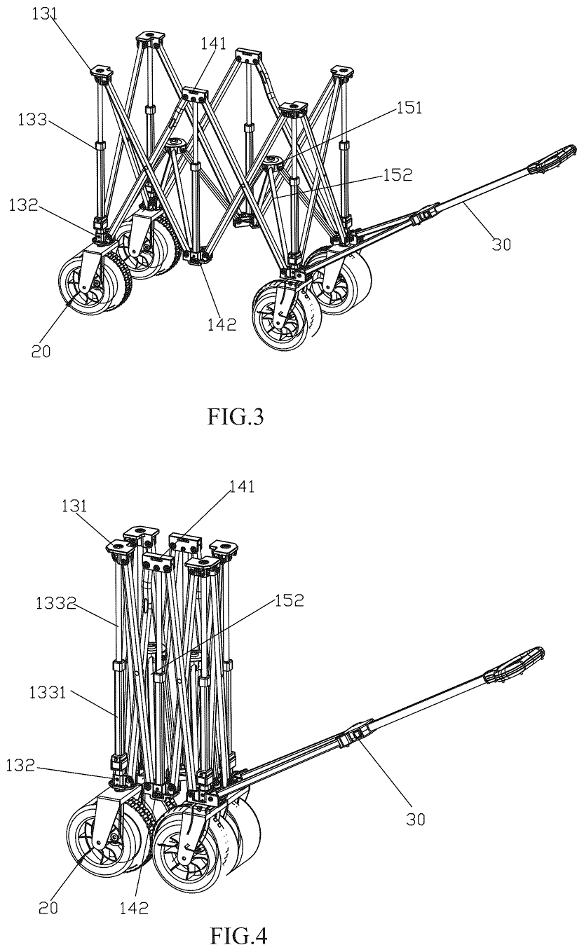

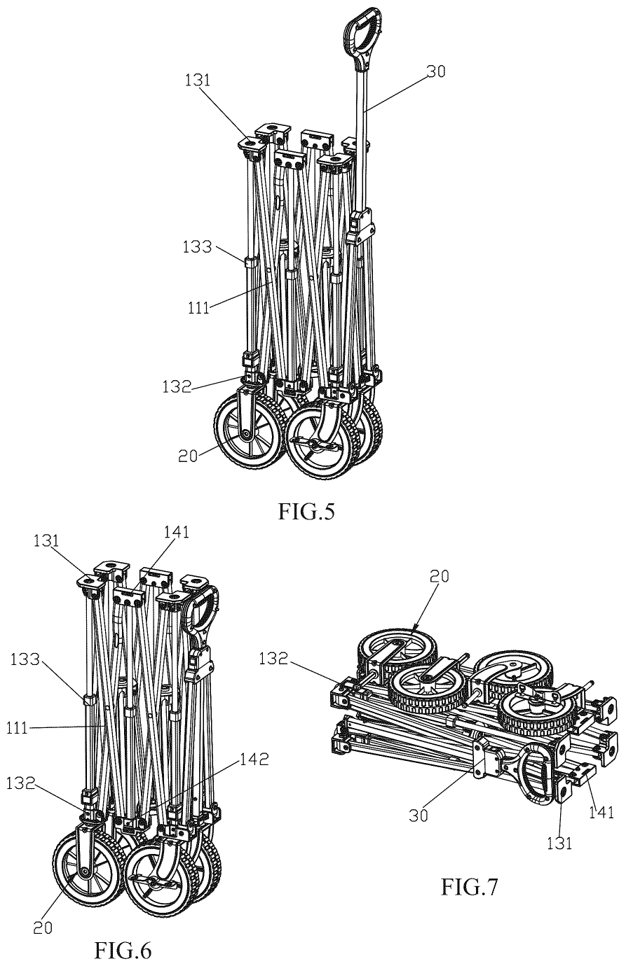

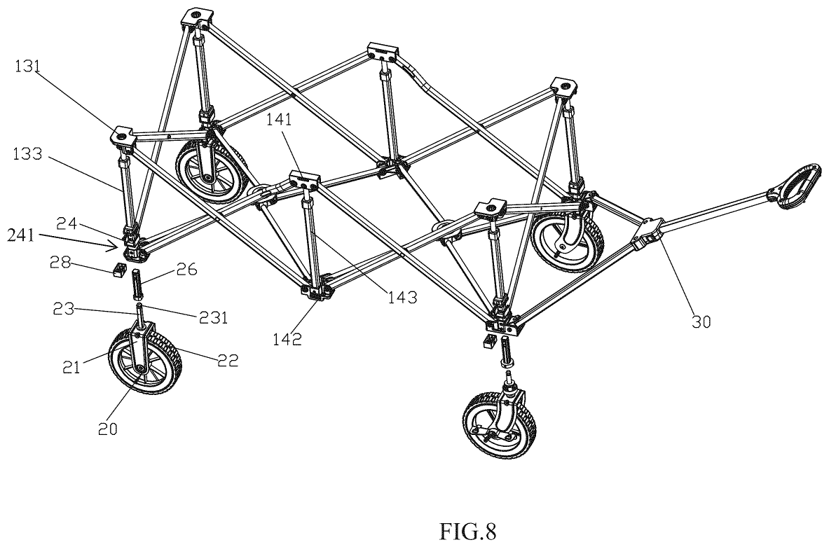

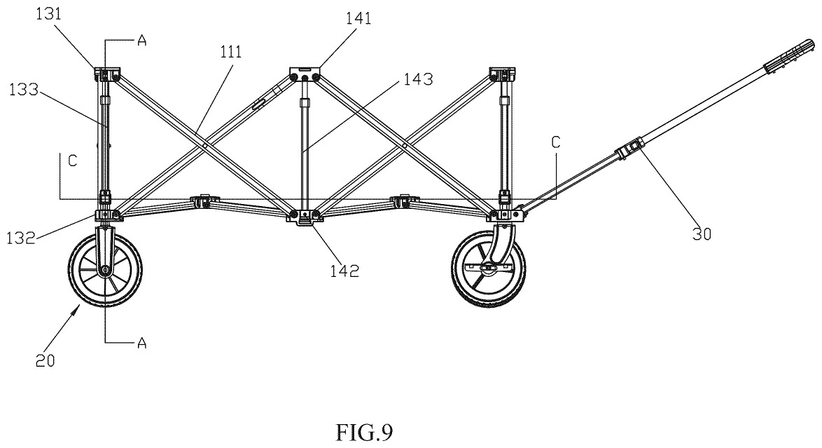

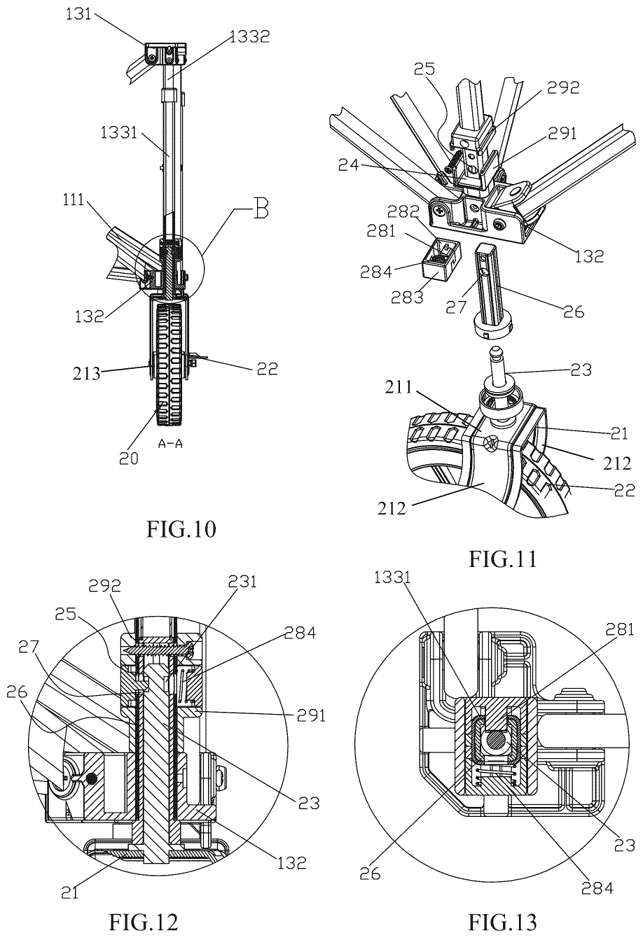

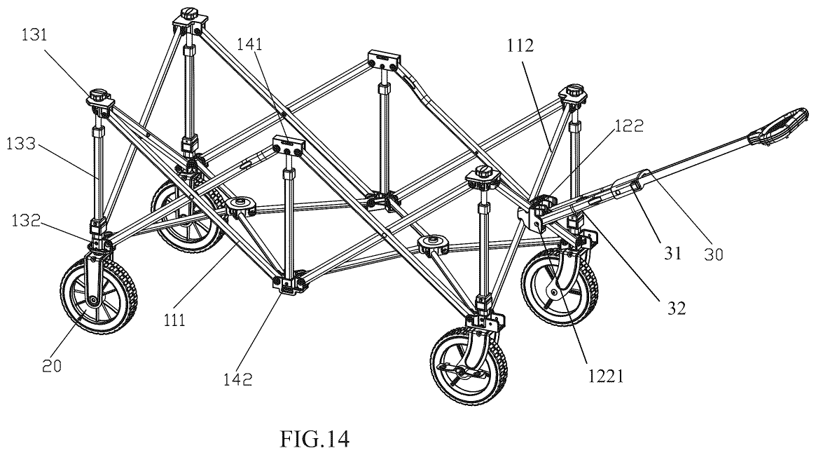

Referring to FIGS. 1 to 13, a portable folding pulling cart comprises a pulling cart frame 100 and a pulling cart cloth 200. The pulling cart frame 100 comprises a folding frame 10 and a wheel mechanism 20 that can be mounted on the folding frame 10.

The folding frame 10 comprises two first scissor mechanisms 11 arranged at intervals in a left-and-right direction and two second scissor mechanisms 12 arranged at intervals in a front-and-rear direction. Each of the two first scissor mechanisms 11 comprises two first scissor units 111, and each of the two second scissor mechanisms 12 comprises a second scissor unit 121. The two first scissor mechanisms 11 and the two second scissor mechanisms 12 are connected to form a rectangular structure. An upper end of each of the two first scissor units 111 and an upper end of the second scissor units 121 adjacent to a corresponding one of the two first scissor units 111 are rotatably connected together through a first upper seat 131. A lower end of each of the two first scissor units 111 and a lower end of the second scissor units 121 adjacent to the corresponding one of the two first scissor units 111 are rotatably connected together through a first lower seat 132. The first upper seat 131 and the first lower seat 132 corresponding to the first upper seat 131 are connected together through a first telescopic rod assembly 133. A middle part of each of the two first scissor mechanisms 11 further comprises a second upper seat 141 and a second lower seat 142. The second upper seat 141 and the second lower seat 142 corresponding to the second upper seat 141 are connected together through a second telescopic rod assembly 143. The second upper seat 141 comprises two upper pivoting points 1411 spaced apart from each other in the front-and-rear direction and aligned with each other in the left-and-right direction. The second lower seat 142 comprises two lower pivoting points 1421 spaced apart from each other in the front-and-rear direction and misaligned with each other in the left-and-right direction. The two first scissor units 111 comprise connecting rods 112, and an upper part of one of connecting rods 112 of the two first scissor units 111, which are adjacent to each other, is bent. The upper ends of the two first scissor units 111 adjacent to each other are respectively pivotally connected to the two upper pivoting points 1411 of the second upper seat 141, and the lower ends of the two first scissor units 111 are respectively pivotally connected to the two lower pivoting points 1421 of the second lower seat 142. The upper part of the one of the connecting rods 112 is bent so that the one of the connecting rods 112 has a Z-shaped structure. Each of the two first scissor units 111 and the second scissor unit 121 comprises two connecting rods 112 of the connecting rods 112 rotatably connected together at a middle position thereof. The two connecting rods 112 of each of the two first scissor units 111 intersect and are respectively arranged inside and outside the folding frame 10. In the two first scissor units 111 adjacent to each other, the upper part of one of the two connecting rods 112 located inside the folding frame 10 of a first one of the two first scissor units 111 is bent outwardly and rotatably connected to a first one of the two upper pivoting points 1411 of the second upper seat 141, and the upper part of one of the two connecting rods 112 located outside the folding frame 10 of a second one of the two first scissor units 111 is rotatably connected to a second one of the two upper pivoting points 1411 of the second upper seat 141, so that a width of the second upper seat 141 of the pulling cart frame 100 is smaller and corresponds to an outer one of the two connecting rods 112 of the first scissor unit intersecting and respectively arranged inside and outside the folding frame 10, thereby increasing a width of an internal space of the pulling cart frame 100, increasing the internal space of the pulling cart frame 100, respectively making the connecting rods 112 of the two first scissor units 111 and the second upper seat 141 independently pivotally connected, and respectively making the connecting rods 112 of the two first scissor units 111 and the second lower seat 142 independently pivotally connected.

The folding frame 10 further comprises a base frame, and the base frame comprises a plurality of radiating mechanisms 15 in a one-to-one correspondence with the two first scissor units 111 of the first scissor mechanism 11 and arranged at intervals in the front-and-rear direction. Each of the plurality of radiating mechanisms 15 comprises a middle seat 151 and four bottom rods 152 that can be rotatably connected to the middle seat 151. Distal ends of two of the four bottom rods 152 located outside the folding frame 10 are respectively rotatably connected to two first lower seats 132 of the first lower seats 132, and distal ends of the other two of the four bottom rods 152 are respectively rotatably connected to two second lower seats 142 of the second lower seats 142, so that an entire base frame can be folded or unfolded with the folding frame 10. The middle seat 151 comprises a position-limiting mechanism to enable the four bottom rods 152 to be maintained at a maximum opening angle when in an unfolded state to improve stability. For example, the middle seat 151 comprises pivoting grooves 1512 for receiving the four bottom rods 152, and an opening of each of the pivoting grooves 1512 provided on the middle seat 151 faces downward. An abutment member 1511 is provided at a bottom of each of the pivot grooves or an outer end of each of the pivoting grooves 1512 as the position-limiting mechanism to achieve an interlocking connection.

The wheel mechanism 20 is located below the first lower seat 132 and can be detachably connected to the folding frame 10, so that the wheel mechanism 20 can be disassembled and occupies a small space after being folded, which is convenient for storage and transportation.

The wheel mechanism 20 comprises a U-shaped wheel frame 21, a wheel 22, and a first connecting shaft 23. The U-shaped wheel frame 21 has a common plate 211 and two split plates 212 respectively fixedly connected to two sides of the common plate 211. The wheel 22 can be rotatably connected between the two split plates 212 of the U-shaped wheel frame 21 through a pivoting shaft 213. The first connecting shaft 23 is vertically fixedly connected to the common plate 211 of the U-shaped wheel frame 21. The first connecting shaft 23 can be assembled and disassembled on the folding frame 10. In a specific structure, the first telescopic rod assembly 133 comprises an outer tube 1331 and an inner tube 1332 slidably arranged in the outer tube 1331. The first lower seat 132 is fixedly connected to an outside of a bottom of the outer tube 1331, and a top of the inner tube 1332 and the first upper seat 131 are fixedly connected together. The bottom of the outer tube 1331 is further fixedly disposed with a mounting member 241, and the mounting member 241 comprises a sliding groove 24 horizontally arranged. An area of the outer tube 1331 corresponding to the sliding groove 24 comprises an outer through hole 25 that penetrates through the outer tube 1331 in an inside-and-outside direction. A fixed sleeve 26 is fixedly inserted into the bottom of the outer tube 1331 from bottom to top, and the fixed sleeve 26 comprises an inner through hole 27 corresponding to the outer through hole 25 (e.g., a protruding ring protrudes from a lower peripheral edge of the fixed sleeve 26 as needed. When the protruding ring abuts the bottom of the outer tube 1331, the inner through hole 27 and the outer through hole 25 are aligned with each other, such that at least one of axes of the inner through hole 27 and the outer through hole 25 are aligned or peripheries of the inner through hole 27 and the outer through hole 25 are aligned). A first annular groove 231 is recessed on an outer peripheral wall of an upper part of the first connecting shaft 23. The first connecting shaft 23 is adapted to be inserted into the fixed sleeve 26, and the first annular groove 231 is aligned with the inner through hole 27. The sliding groove 24 of the mounting member 241 is slidably disposed with a sliding seat 28 that can slide horizontally. The sliding seat 28 comprises a first insertion portion 281, and the first insertion portion 281 extends into the outer through hole 25 and the inner through hole 27 and is inserted into the first annular groove 231, so that the wheel mechanism 20 and the first telescopic rod assembly 133 are axially interlocked. The wheel mechanism 20 and the folding frame 10 can be assembled and disassembled, which is convenient for assembly and disassembly, and a connection is firm, stable, and reliable.

In this embodiment: the sliding seat 28 comprises a first side plate 282 and a second side plate 283 that are relatively fixed and horizontally spaced apart. The first side plate 282 is located outside a first side of the outer tube 1331 where the outer through hole 25 is provided. The first side plate 282 is fixedly disposed with the first insertion portion 281. The second side plate 283 is located outside a second side of the outer tube 1331 that faces away from the first side. A first elastic body 284 is disposed between the second side plate 283 and the outer tube 1331, so that the first elastic body 284 stores energy when pressed and the first insertion portion 281 is separated from the first annular groove 231. When the first elastic body 284 is released from being pressed, the first elastic body 284 releases the energy to extend into the fixed sleeve 26, so that the first insertion portion 281 can be inserted into the first annular groove 231, thereby realizing automatic locking and improving the convenience of locking. Preferably, the sliding seat 28 comprises a rectangular frame, and two side plates of the rectangular frame facing each other define the first side plate and the second side plate. The outer tube 1331 is located inside the rectangular frame, and a structure is firm and easy to operate. The mounting member 241 comprises a lower mounting portion 291 and an upper mounting portion 292, and the sliding groove 24 is formed between the upper mounting portion 292 and the lower mounting portion 291, which is easy to produce and assemble.

As needed, the pulling cart frame 100 further comprises a first pulling rod mechanism 30, and the first pulling rod mechanism 30 comprises a first assembly seat 31, two first pulling rods 32 that can be rotatably connected to the first assembly seat 31, and a first gripping rod 33 connected to the first assembly seat 31. The first gripping rod 33 and the two first pulling rods 32 are respectively located on two sides of the first assembly seat 31. The two first pulling rods 32 are respectively rotatably connected to the two first lower seats 132 of the first lower seats 132 located on one of the two second scissor mechanisms 12, so that when the pulling cart frame 100 is folded or unfolded, the two first pulling rods 32 correspondingly abut each other or are splayed. The first gripping rod 33 can be swingably connected to the first assembly seat 31 and is disposed with a locking mechanism 34, so that the first gripping rod 33 can swing relatively between a first position and a second position. When located in the first position, the first gripping rod 33 and the two first pulling rods 32 are respectively located on the two sides of the first assembly seat 31, and the locking mechanism 34 is locked to maintain the first position. The locking mechanism 34 is released to rotate the first gripping rod 33 to be located in the second position, and the first gripping rod 33 and the two first pulling rods 32 are abutted together.

The pulling cart cloth 200 comprises a base cloth and a peripheral wall extending upward from a periphery of the base cloth. An upper periphery of the peripheral wall is connected to the first upper seats 131 and the second upper seats 141, and the base cloth is connected to the middle seat 151, the first lower seats 132, and the second lower seats 142.

### Embodiment 2

Referring to FIG. 14, a portable folding pulling cart is provided, and the portable folding pulling cart is different from Embodiment 1 in that the two connecting rods 112 of one of the two second scissor mechanisms 12 are rotatably connected together through a middle portion seat 122, and the middle portion seat 122 comprises two middle pivoting points 1221. The two first pulling rods 32 of the first pulling rod mechanism 30 are respectively rotatably connected to the two middle pivoting points 1221, and the two first pulling rods 32 abut each other at this time. When necessary, a single first pulling rod 32 can be provided instead of two first pulling rods 32, and the first assembly seat 31 can also be fixedly connected to the single first pulling rod 32.

### Embodiment 3

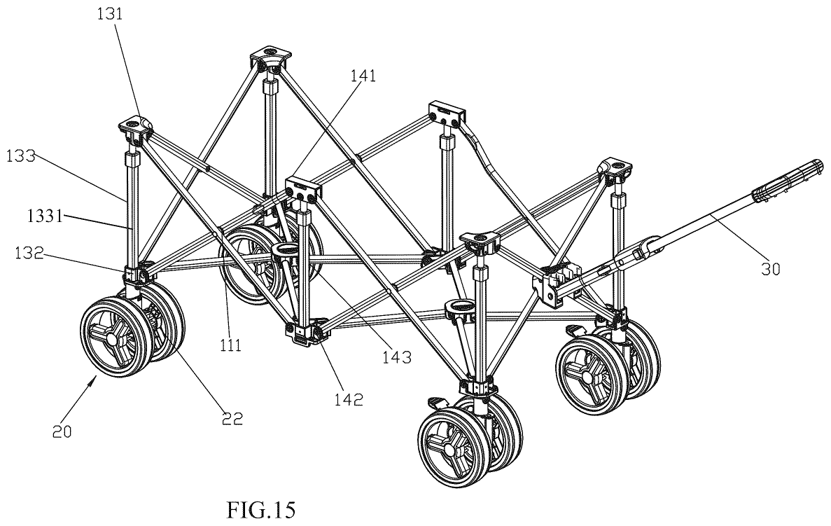

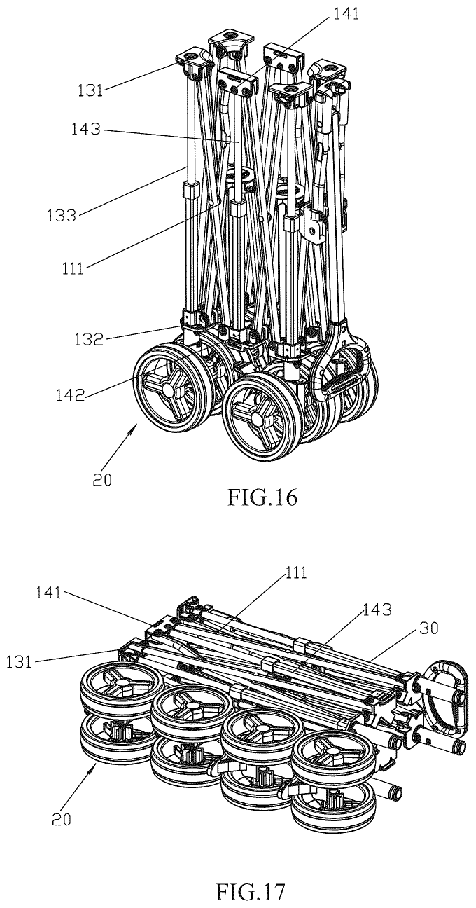

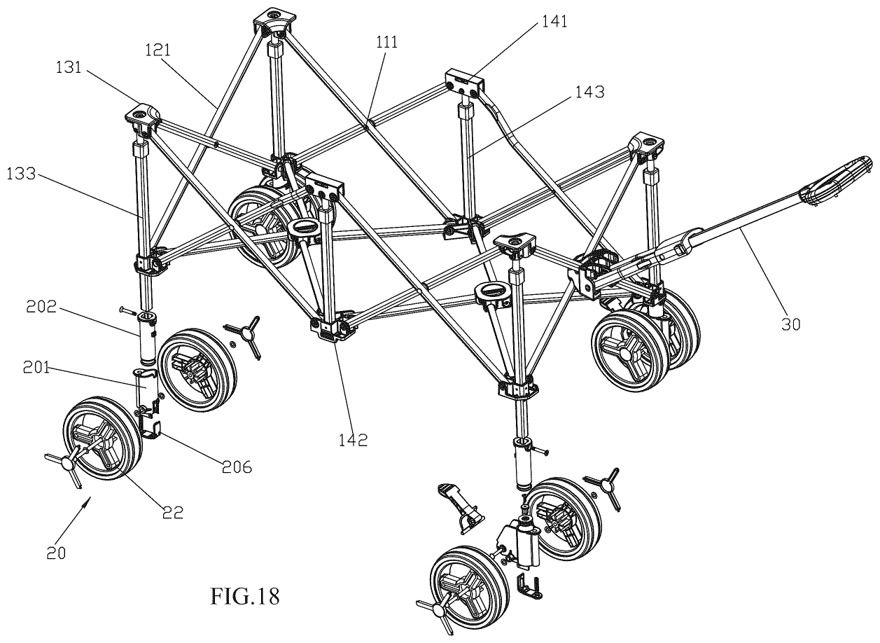

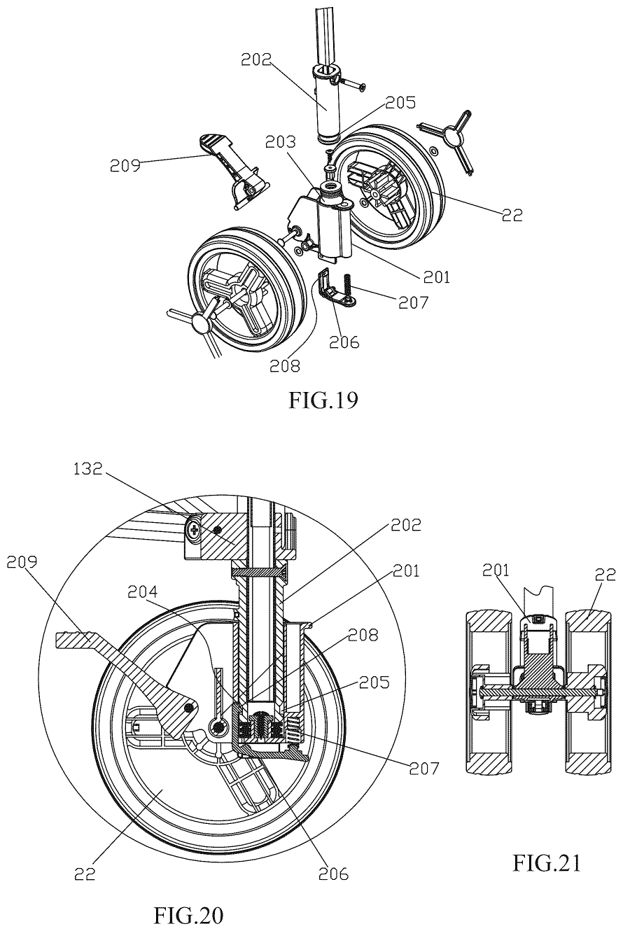

Referring to FIGS. 15 to 21, a portable folding pulling cart is provided, and the portable folding pulling cart is different from Embodiment 1 in that the wheel mechanism 20 comprises a supporting frame 201 and two wheels 22 that can be rotatably connected to two sides of the supporting frame 201. A second connecting shaft 202 is fixedly provided at the bottom of the outer tube 1331, and the supporting frame 201 and the second connecting shaft 202 can be assembled together and detached from each other. In a specific structure: the supporting frame 201 is recessed with an insertion hole 203, and the supporting frame 201 comprises a first through hole 204 that penetrates through an inside and an outside of the insertion hole 203. A lower part of the second connecting shaft 202 is recessed with a second annular groove 205, and the second connecting shaft 202 is adapted to be inserted into the insertion hole 203. The wheel mechanism 20 further comprises an L-shaped frame 206. A middle part of the L-shaped frame 206 is rotatably connected to a bottom of the supporting frame 201, and a second elastic body 207 is disposed between a first end of the L-shaped frame 206 and the bottom of the supporting frame 201. A second insertion portion 208 is fixedly disposed at a second end of the L-shaped frame 206, and the second insertion portion 208 extends into the first through hole 204 and is inserted into the second annular groove 205. The first end of the L-shaped frame 206 is pressed to compress the second elastic body 207 to store energy, and the second insertion portion 208 at the second end of the L-shaped frame 206 is separated from the second annular groove 205 so that the wheel mechanism 20 can be disassembled. When the second elastic body 207 is released from being pressed, the energy of the second elastic body 207 is released, and the second insertion portion 208 at the second end of the L-shaped frame 206 is inserted into the first through hole 204 and the second annular groove 205 due to an elastic force of the second elastic body 207. The portable folding pulling cart is easy to operate, has a simple structure, and occupies a small space. The wheel mechanism 2—can be provided with a brake mechanism 209 as needed.

### Embodiment 4

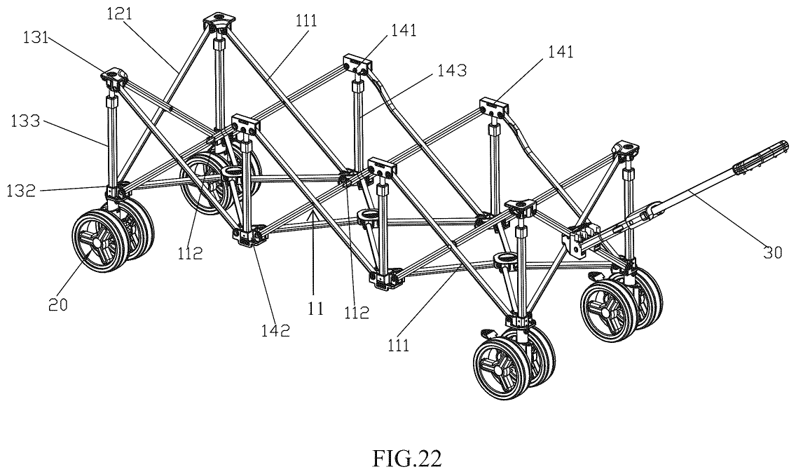

Referring to FIG. 22, a portable folding pulling cart differs from Embodiment 1 in that each of the two first scissor mechanisms 11 comprises three first scissor units 111, each adjacent two first scissor units 111 of the three first scissor units 111 are provided with the second upper seat 141 and the second lower seat 142, and the upper part of one of the connecting rods 112 of one of each adjacent two first scissor units 111 is bent so that the width of each of the second upper seats 141 is smaller.

The above description is only preferred embodiments of the present disclosure, and therefore should not be used to limit the scope of implementation of the present disclosure. That is, equivalent changes and modifications made according to the patent scope of the present disclosure and the contents of the specification should still fall within the scope covered by the present disclosure.

What is claimed is:

1. A portable folding pulling cart, comprising:
a pulling cart frame, wherein:
the pulling cart frame comprises a folding frame and a wheel mechanism configured to be mounted on the folding frame,
the folding frame comprises two first scissor mechanisms arranged at intervals in a left-and-right direction and two second scissor mechanisms arranged at intervals in a front-and-rear direction,
each of the two first scissor mechanisms comprises at least two first scissor units,
each of the two second scissor mechanisms comprises at least one second scissor unit,
the two first scissor mechanisms and the two second scissor mechanisms are connected to form a rectangular structure,
an upper end of each of the at least two first scissor units and an upper end of the at least one second scissor unit adjacent to a corresponding one of the at least two first scissor units are rotatably connected together through a first upper seat,
a lower end of each of the at least two first scissor units and a lower end of the at least one second scissor unit adjacent to the corresponding one of the at least two first scissor units are rotatably connected together through a first lower seat,
a middle part of each of the two first scissor mechanisms further comprises a second upper seat and a second lower seat,
the second upper seat comprises two upper pivoting points,
the two upper pivoting points are spaced apart from each other in the front-and-rear direction and aligned with each other in the left-and-right direction,
the second lower seat comprises two lower pivoting points,
each of the at least two first scissor units comprises connecting rods,
an upper part of one of the connecting rods of adjacent two first scissor units of the at least two first scissor units is bent,
the upper ends of the adjacent two first scissor units are respectively pivotally connected to the two upper pivoting points of the second upper seat, and
the lower ends of the adjacent two first scissor units are respectively pivotally connected to the two lower pivoting points of the second lower seat.

2. The portable folding pulling cart according to claim 1, wherein:
the first upper seat and the first lower seat corresponding to the first upper seat are connected together through a first telescopic rod assembly, and
the second upper seat and the second lower seat corresponding to the second upper seat are connected together through a second telescopic rod assembly.

3. The portable folding pulling cart according to claim 1, wherein:
the two lower pivoting points on the second lower seat are spaced apart from each other in the front-and-rear direction and misaligned with each other in the left-and-right direction.

4. The portable folding pulling cart according to claim 1, wherein:
each of the at least two first scissor units and the at least one second scissor unit comprises two connecting rods of the connecting rods rotatably connected together at a middle position of the two connecting rods,
the two connecting rods of each of the at least two first scissor units intersect and are respectively arranged inside and outside the folding frame, and
in the adjacent two first scissor units:
the upper part of one of the two connecting rods located inside the folding frame of a first one of the adjacent two first scissor units is bent outwardly and rotatably connected to a first one of the two upper pivoting points of the second upper seat, and
the upper part of one of the two connecting rods located outside the folding frame of a second one of the adjacent two first scissor units is rotatably connected to a second one of the two upper pivoting points of the second upper seat.

5. The portable folding pulling cart according to claim 1, wherein:
the folding frame further comprises a base frame,
the base frame comprises a plurality of radiating mechanisms in a one-to-one correspondence with the at least two first scissor units of each of the two first scissor mechanisms and arranged at intervals in the front-and-rear direction,
each of the plurality of radiating mechanisms comprises a middle seat and four bottom rods that are configured to be rotatably connected to the middle seat,
distal ends of two of the four bottom rods are respectively rotatably connected to two first lower seats of the first lower seats, and
distal ends of another two of the four bottom rods are respectively rotatably connected to two second lower seats of the second lower seats.

6. The portable folding pulling cart according to claim 1, wherein:
the wheel mechanism is located below the first lower seat and is configured to be detachably connected to the folding frame.

7. The portable folding pulling cart according to claim 2, wherein:
the wheel mechanism comprises a U-shaped wheel frame, a wheel, and a first connecting shaft,
the U-shaped wheel frame has a common plate and two split plates respectively fixedly connected to two sides of the common plate,
the wheel is configured to be rotatably connected between the two split plates,
the first connecting shaft is connected to the common plate,
the first connecting shaft is configured to be assembled and disassembled on the folding frame,
a first annular groove is recessed on an upper part of the first connecting shaft,
the first telescopic rod assembly comprises an outer tube and an inner tube slidably arranged in the outer tube,
the first lower seat is fixedly connected to a bottom of the outer tube,
a top of the inner tube and the first upper seat are fixedly connected together,
the bottom of the outer tube is fixedly disposed with a mounting member,
the mounting member comprises a sliding groove horizontally arranged,
an area of the outer tube corresponding to the sliding groove comprises an outer through hole that penetrates through the outer tube in an inside-and-outside direction,
a fixed sleeve is fixedly disposed in the bottom of the outer tube,
the fixed sleeve comprises an inner through hole corresponding to the outer through hole,
the first connecting shaft is adapted to be disposed in the fixed sleeve,
the sliding groove of the mounting member is slidably disposed with a sliding seat that is configured to slide horizontally,
the sliding seat comprises a first insertion portion, and
the first insertion portion is configured to extend into the outer through hole and the inner through hole and be disposed in the first annular groove.

8. The portable folding pulling cart according to claim 7, wherein:
the sliding seat comprises a first side plate and a second side plate that are relatively fixed and horizontally spaced apart,
the first side plate is located outside a first side of the outer tube where the outer through hole is provided,
the first side plate is fixedly disposed with the first insertion portion,
the second side plate is located outside a second side of the outer tube that faces away from the first side, and
a first elastic body is disposed between the second side plate and the outer tube.

9. The portable folding pulling cart according to claim 8, wherein:
the sliding seat comprises a rectangular frame,
two side plates of the rectangular frame facing each other define the first side plate and the second side plate,
the outer tube is located inside the rectangular frame,
the mounting member comprises a lower mounting portion and an upper mounting portion, and
the sliding groove is formed between the upper mounting portion and the lower mounting portion.

10. The portable folding pulling cart according to claim 2, wherein:
the wheel mechanism comprises a supporting frame and two wheels configured to be rotatably connected to two sides of the supporting frame,
the first telescopic rod assembly comprises an outer tube and an inner tube slidably arranged in the outer tube,
the first lower seat is fixedly connected to a bottom of the outer tube,
a top of the inner tube and the first upper seat are fixedly connected together,
a second connecting shaft is fixedly provided at the bottom of the outer tube,
the supporting frame and the second connecting shaft are configured to be assembled together and detached from each other,
a lower part of the second connecting shaft is recessed with a second annular groove,
the supporting frame is recessed with an insertion hole,
the supporting frame comprises a first through hole that penetrates through an inside and an outside of the insertion hole,
the second connecting shaft is adapted to be disposed in the insertion hole,
the wheel mechanism further comprises an L-shaped frame,
a middle part of L-shaped frame is rotatably connected to a bottom of the supporting frame,
a second elastic body is disposed between a first end of the L-shaped frame and the bottom of the supporting frame,
a second insertion portion is fixedly disposed at a second end of the L-shaped frame, and
the second insertion portion is configured to extend into the first through hole and be disposed in the second annular groove.
